(19) United States
(12) Patent Application Publication
(10) Pub. No.: US 2011/0318520 A1
(43) Pub. Date: Dec. 29, 2011

(54) MOLDED ARTICLE AND METHOD FOR MAKING THE SAME

(75) Inventors: KUN-TSAN WU, Shindian (TW); LI-WEN TIEN, Shindian (TW)

(73) Assignee: FIH (HONG KONG) LIMITED, Kowloon (HK)

(21) Appl. No.: 12/861,907

(22) Filed: Aug. 24, 2010

(30) Foreign Application Priority Data
Jun. 28, 2010 (CN) 201010211062.9

(51) Int. Cl. B44F 1/06; B29C 45/14

(52) U.S. Cl. 428/38; 264/261

(57) ABSTRACT

A molded article includes a first layer, a second layer and a third layer, the first layer and the third layer are transparent, the first layer has first patterns formed thereon, and the third layer has second patterns formed thereon, the second patterns have the same shape and size as the first patterns. The first layer and the third layer are joined to the two opposite sides of the second layer by injection molding, where the first and second patterns align.

### CROSS-REFERENCE TO RELATED APPLICATIONS

This application is related to co-pending U.S. patent applications (Attorney Docket No. US33956 and US34278), both entitled “MOLDED ARTICLE AND METHOD FOR MAKING THE SAME”, by Kun-Tsan Wu. Such applications have the same assignee as the present application. The above-identified application is incorporated herein by reference.

### BACKGROUND

1. Technical Field

The present disclosure relates to a molded article and a method for making the molded article.

2. Description of Related Art

Molded articles, such as a molded housing of electronic device, can be fabricated by injection molding. A way of inserting molding label (IML) is used widely, to fabricate a decorative film having pattern on the plastic material to form the molded article. However, three-dimensional aesthetic effects produced by the common pattern may be insufficient for some consumers.

Therefore, there is room for improvement within the art.

### BRIEF DESCRIPTION OF THE DRAWINGS

Many aspects of the present molded article and method for making the same can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the diagrams.

FIG. 1 is a sectional schematic view of a molded article according to a first exemplary embodiment.

FIG. 2 is an exploded schematic view of part of the molded article shown in FIG. 1.

FIG. 3 is a sectional schematic view during molding of the molded article in first injection molding step.

FIG. 4 is a sectional schematic view during molding of the molded article in second injection molding step.

FIG. 5 is a cross-sectional schematic view of a molded article according to a second exemplary embodiment.

FIG. 6 is a cross-sectional schematic view of a molded article according to a third exemplary embodiment.

### DETAILED DESCRIPTION

The disclosed molded article can be a housing of electronic device, such as a mobile phone or personal digital assistant.

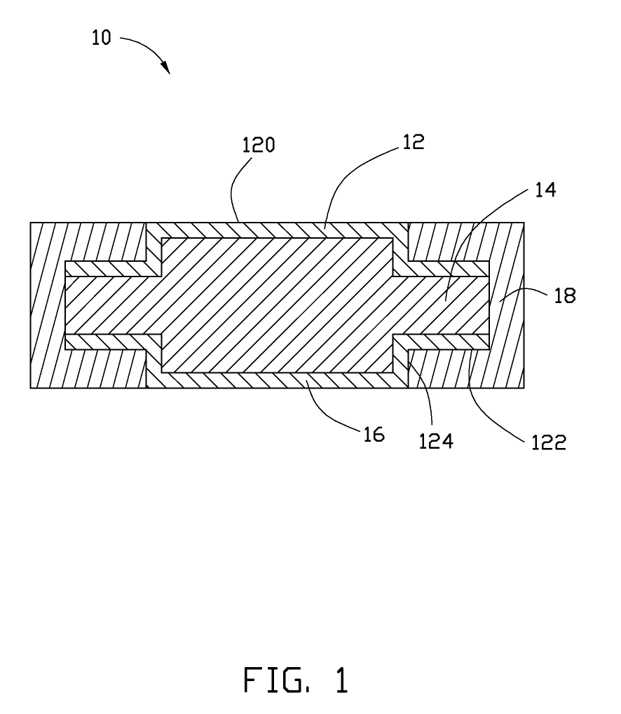

FIG. 1 shows a molded article 10 according to a first exemplary embodiment including a first layer 12, a second layer 14, and a third layer 16.

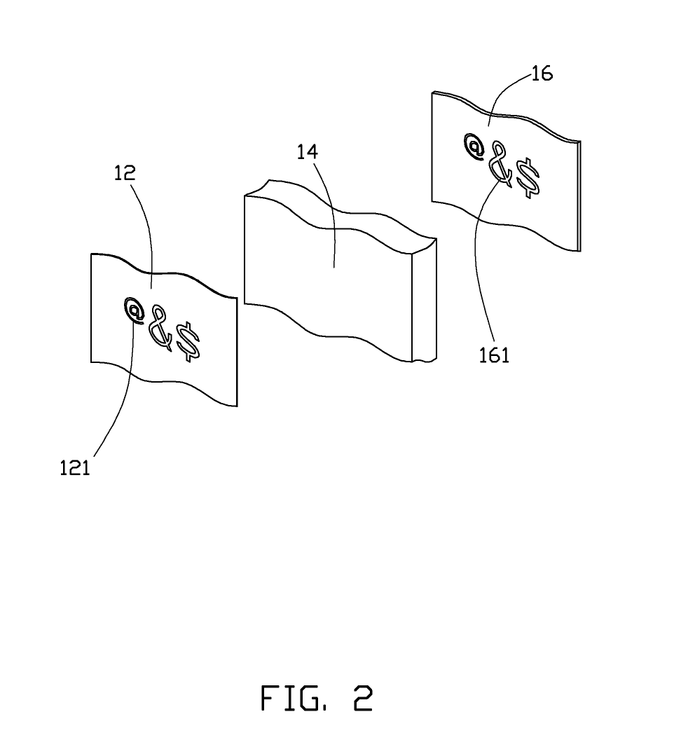

Referring to FIG. 2, the first layer 12 and the third layer 16 both can be films with patterns printed thereon. Either of the films can be made from transparent materials including resin, glass, textile etc. The first layer 12 may have first patterns 121 formed on the inner surface facing the second layer 14. The third layer 16 may have second patterns 161 formed on the inner surface facing the second layer 14. The first patterns 121 have the same shape and size as the second patterns 161 and align with the second patterns 161. The second layer 14 may be made of a transparent plastic material selected from a group including polycarbonate, polymethyl methacrylate, polystyrene, or any desired combination thereof. The first layer 12 and the third layer 16 are combined on the opposite sides of the second layer 14 to form the molded article 10. The first patterns 121 aligns with the second patterns 161 in a line, and the first patterns 121 and the second patterns 161 all in the inner of the molded article 10 and can be protected effectively. Understandably, adhesive (not shown) can placed to reinforce the bond between the layers. The adhesive can be made of polyurethane, epoxy resin, or the combination of the two.

The molded article 10 includes a main portion 120 and an edge portion 122 extending at the periphery of the main portion 120. The edge portion 122 laterally extends from the middle portion of the side wall of the main portion 120, and is shorter than the main portion 120, correspondingly to form two opposite step walls 124 on the side wall of the main portion 120.

To prevent the edge portion 122 of the molded article 10 from separating at the edge thereof, the molded article 10 further includes a sealing layer 18. The sealing layer 18 may be made of plastic materials, the sealing layer 18 encloses the edge portion 122 and fills in the area that is enclosed by the edge portion 122 and the step wall 124. The end surfaces of the sealing layer 18 abut against the step walls 124 to cover the end surfaces. The sealing layer 18 can be formed to enclose the edge of the molded article 10 by a second injection molding step.

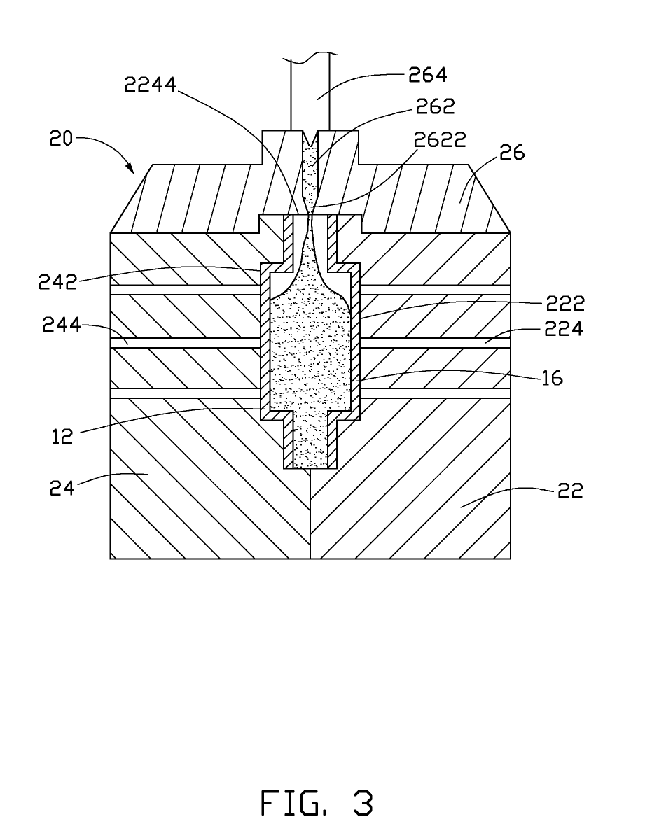

Referring to FIG. 3, to fabricate the molded article 12, a first layer 12 which can be a transparent film, for example, has first patterns 121 printed on one surface thereof. The third layer 16 which can be a transparent film, for example, has second patterns 161 printed on one surface thereof. A first mold 20 includes a female mold 22, a male mold 24 engaging with the female mold 22, and a feeding plate 26 engaging with the female mold 22 and the male mold 24. The female mold 22 defines a cavity 222 and first suction holes 224. The first suction holes 224 run through the female mold 22 and communicate with the cavity 222. The male mold 24 forms a core 242 and second suction holes 244 running through the male mold 24 and the core 242. The female mold 22 engages with the male mold 24, and the core 22 extends into the cavity 222 to form a chamber 2244. The feeding plate 26 is arranged to engage with the female mold 22 and the male mold 24. The feeding plate 26 defines a channel 262 for passing of molding plastics. The channel 262 has a nozzle 2622 to communicate with the chamber 2244.

The first layer 12 is secured onto the core 242 by a vacuum communicating with the second suction holes 244, with the surface having the first patterns 121 facing the cavity 222 of the female mold 22. The third layer 16 is secured into the cavity 222 by a vacuum communicating with the first suction holes 224, with the surface having the second patterns 161 facing the core 242 of the male mold 24. The female mold 22 engages with the male mold 24, and the core 242 extends into the cavity 222 to form the chamber 2244. The feeding plate 26 engages with the female plate 22 and the male plate 24, enabling the nozzle 2622 of the channel 262 to communicate with the chamber 2244. A first transparent plastic molding material is injected into the chamber 2244 through the channel 262 and forms the second layer 14. The second layer 14 integrally combines with the first layer 12 and the third layer 16 to form a preform article (not labeled). The preform article can be cooled and taken out of the first mold 20. The preform article has the main portion 120, the edge portion 122, and the two opposite step walls 124 on the side wall of the main portion 120, the first patterns 121 align with the second patterns 161 in a line.

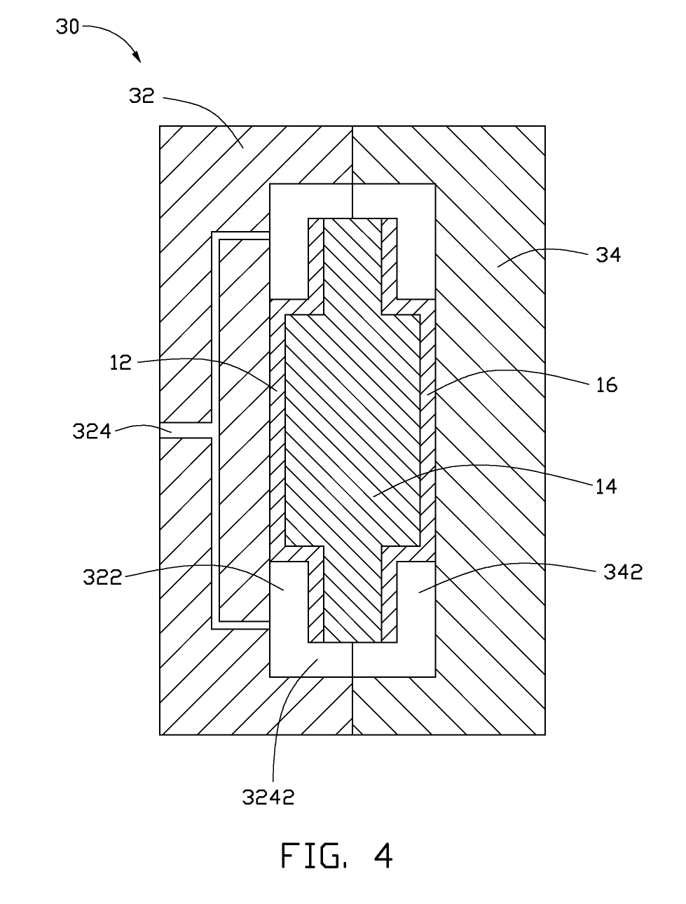

Referring to FIG. 4, a second mold 30 is provided, the second mold 30 includes a female mold 32 and a male mold 34 engaging with the female mold 32. The female mold 32 defines a cavity 322 and a second channel 324. The second channel 324 runs through the female mold 32 and communicate with the cavity 322. The male mold 34 forms a core 342 to engage with the cavity 322. The female mold 32 engages with the male mold 34, the core 342 extends into the cavity 322 to form a second chamber 3242 having shape and size as the molded article 10.

The preform article is placed into the cavity 322, then, the female mold 32 engages with the male mold 34, and the core 342 extends into the cavity 322 to form the chamber 3242. A second plastic molding material is injected into the second chamber 3242 through the second channel 324 and integrally combine the preform article to form the molded article 10. The second plastic molding material forms the sealing layer 18. The sealing layer 18 encloses the edge portion 122 and fills in the area that is enclosed by the edge portion 122 and the step wall 124. In this case, the end surfaces of the sealing layer 18 abut against the step walls 124 to cover the end surfaces. The molded article 10 can then be removed.

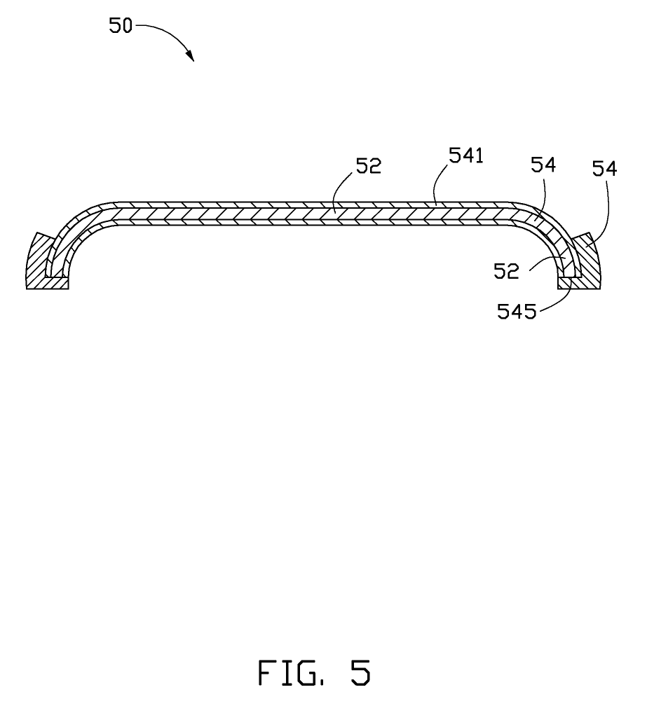

It is to be understood that the molded article can have other structures. For example, FIG. 5 shows another molded article 50 including a main portion 52 and an edge portion 54 having the same thickness as the main portion 52. Accordingly, the edge portion 54 can evenly connect to the main portion 52. A sealing layer 56 has an L-shaped cross-section and covers the end surface 545 of the edge portion 54. A portion of the sealing layer 56 extends to a first layer 541 of the molded article 50 and covers the periphery of the first layer 541.

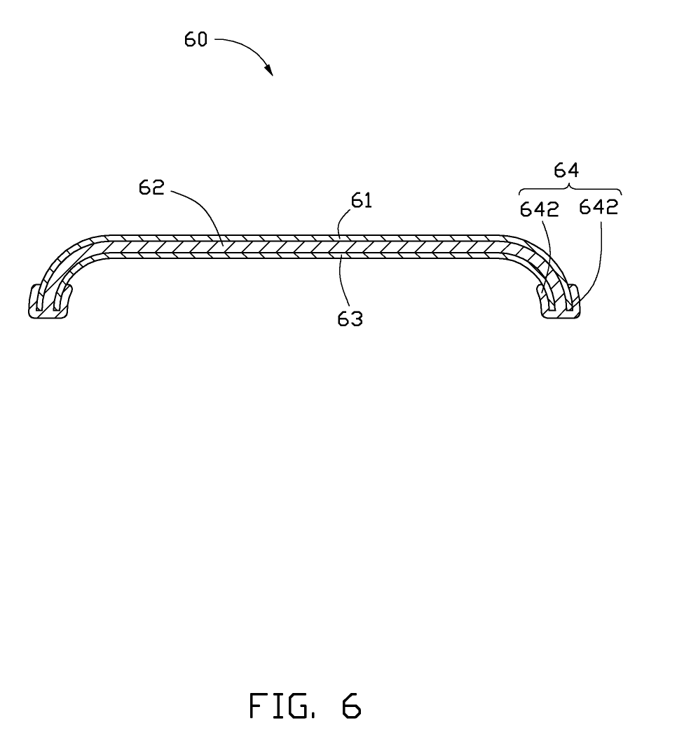

FIG. 6 shows a third molded article 60 including a first layer 61, a second layer 62, a third layer 63, and a sealing layer 64. The sealing layer 64 can be integrally formed with a second layer 62. During the injection molding, the second layer 62 extends to form two branches 642. One branch 642 encloses the periphery of the first layer 61, and the other branch 642 encloses the periphery of the third layer 63.

It is to be understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A molded article, comprising:
a first transparent layer having first patterns formed thereon;
a second transparent layer; and
a third transparent layer having second patterns formed thereon, the second patterns having same shape and size as the first patterns; wherein:
the first layer and the third layer are joined to opposite sides of the second layer by injection molding, the first patterns aligning with the second patterns.

2. The molded article as claimed in claim 1, wherein the molded article includes a main portion and an edge portion, the edge portion laterally extends form the middle portion of the side wall of the main portion and is shorter than the main portion, thereby forming opposite step walls on the side wall of the main portion.

3. The molded article as claimed in claim 1, wherein the molded article includes a sealing layer, the sealing layer encloses the edge portion and fills in the area that enclosed by the edge portion and the step wall, with the end surfaces of the sealing layer abutting against the step walls to cover the end surfaces.

4. The molded article as claimed in claim 3, wherein the sealing layer is formed integrally with the second layer, the second layer extends and forms two branches to form the sealing layer, with one branch enclosing the periphery of the first layer, and the other branch enclosing the periphery of the third layer.

5. The molded article as claimed in claim 3, wherein the sealing layer is formed by a second injection molding step.

6. The molded article as claimed in claim 1, wherein the molded article includes a main portion and an edge portion evenly connecting to the main portion, the molded article includes a sealing layer, the sealing layer has an L-shaped cross-section, the sealing layer covers the end surface of the edge portion and extends to cover the periphery of the first layer.

7. A molded article, comprising:
a transparent first layer having first patterns formed thereon;
a transparent third layer having second patterns formed thereon;
a second layer made of plastic materials and arranged between the first layer and third layer, and
a sealing layer made of plastic materials; wherein:
the first layer and the third layer are joined to the two opposite sides of the second layer by injection molding, the sealing layer encloses the edges of the molded article to prevent separating at the edges thereof, the first patterns align with the second patterns.

8. A method for making a molded article, comprising:
providing a mold, the mold including a male mold and a female mold engaging with the male mold, one of the male mold and the female mold defining a cavity, and the other forming a core engaging with the cavity to form a chamber;
providing a first layer having first patterns printed thereon and placing the first layer on the core;
providing a third layer having second patterns printed thereon and placing the third layer into the cavity;
engaging the female mold with the male mold, injecting a transparent plastic material into the chamber, the plastic material combining the first layer and the third layer to form the molded article, the plastic material forming a second layer between the first layer and the third layer, the first patterns aligning with the second patterns;
opening the mold and taking the molded article out.

9. The method for making the molded article as claimed in claim 8, wherein the method further includes a step to make a sealing layer, the second layer extends to form the sealing layer, the sealing layer encloses the edges of the molded article.

10. The method for making the molded article as claimed in claim 8, wherein the method further includes a step to make a sealing layer, the sealing layer is formed by a second injection molding step.
